(19) United States
(12) Patent Application Publication
(10) Pub. No.: US 2017/0046164 A1
(43) Pub. Date: Feb. 16, 2017

(54) HIGH PERFORMANCE RECOVERY FROM MISSPECULATION OF LOAD LATENCY

(71) Applicant: QUALCOMM Incorporated, San Diego, CA (US)

(72) Inventors: Raghavan MADHAVAN, Cary, NC (US); Kiran RAVI SETH, Raleigh, NC (US); Yusuf Cagatay TEKMEN, Raleigh, NC (US); Rodney Wayne SMITH, Raleigh, NC (US)

(21) Appl. No.: 14/865,150

(22) Filed: Sep. 25, 2015

Related U.S. Application Data
(60) Provisional application No. 62/205,624, filed on Aug. 14, 2015.

(51) Int. Cl. G06F 9/38; G06F 9/30

(52) U.S. Cl. CPC G06F 9/3861; G06F 9/30101; G06F 9/30145

(57) ABSTRACT

A load instruction, for loading a register among a set of registers, is scheduled. Associated with scheduling the load instruction, a register dependency vector, corresponding to the register, is set to a state identifying the load instruction. A consumer instruction is scheduled, having a set of operand register and a target register, the register being in the set of operand registers. A target register dependency vector, corresponding to the target register is set in the memory. Based at least in part on the register being in the set of operand registers, a value of the target register dependency vector identifies the load instruction. Optionally, upon receiving a cache miss notice associated with the load instruction, the target register dependency vector is retrieved.

### CLAIM OF PRIORITY UNDER 35 U.S.C. §119

The present Application for Patent claims priority to Provisional Application No. 62/205,624 entitled HIGH-PERFORMANCE RECOVERY FROM MISPECULATION OF LOAD LATENCY, filed Aug. 14, 2015, and assigned to the assignee hereof and hereby expressly incorporated by reference herein.

### FIELD OF DISCLOSURE

The present disclosure pertains to load latency speculation and recovery from misspeculation.

### BACKGROUND

A pipeline processor can fetch a sequence of program instructions, in their original program order, and schedule certain of the instructions for execution out of order. The out of order scheduling can accommodate, to a varying extent, operands of different instructions being available at different times. The out of order scheduling can also accommodate dependencies, i.e., instructions having as operands results of other instructions. Goals of out of order scheduling include uninterrupted pipeline operation.

One complication in attaining uninterrupted operation is the uncertainty as to whether memory accesses will be low latency (e.g., approximately one to five cycles) access of a local cache or high latency (e.g., hundreds of cycle) access of a larger “main” memory. Which latency applies is not known until the hit/miss result of the cache access is known, i.e., the access is low latency if it is a hit and high latency if it is a miss.

Techniques for run-time estimation of cache accesses being a hit or miss, in other words, speculation of latency, are known. Use of speculated latency for out of order scheduling of instructions is also known.

A percentage of the speculated latencies, though, will be incorrect, i.e., misspeculations. One indicator of a misspeculation can be receipt of a “miss” indicator, identifying an instruction that included a memory access (e.g., loading of a register with a data in memory), but encountered a miss when it looked for that data in the cache. In response, a recovery can attempt to identify currently scheduled instructions (e.g., an arithmetic operation having the register as an operand) that depend on the data, and were scheduled relying on the data being available with low latency. Such instructions can be termed “dependent” instructions. Re-scheduling dependent instructions can be termed “replaying,” and processes of identifying and replaying dependent instructions can be termed “recovery process.”

There are problems, though, with known conventional techniques for identifying dependent instructions.

For example, one known conventional technique is to scan various stages of a pipeline in response to a miss indicator. The scan can look at the operand registers of all instructions to identify which, if any, depend on the data associated with the miss. However, this technique has costs. For example, capabilities for scanning multiple pipeline stages can incur hardware costs as well as overhead, particularly in high frequency designs. In addition, such techniques can block instruction selection, for a duration, which can impede independent instructions.

Another known conventional technique includes blocking instruction selection for multiple cycles, to allow the instructions to reach, for example, the “dispatch” stage. Then, identification can be made of whether the instructions need to be replayed or not. This technique, though, also has costs. For example, instruction selection is blocked for multiple cycles, so independent instructions suffer a larger penalty. Also, scheduler queue positions may be held by instructions and not released until the instructions are past the dispatch stage.

### SUMMARY

This Summary identifies features and aspects of some example aspects, and is not an exclusive or exhaustive description of the disclosed subject matter. Whether features or aspects are included in, or omitted from this Summary is not intended as indicative of relative importance of such features. Additional features and aspects are described, and will become apparent to persons skilled in the art upon reading the following detailed description and viewing the drawings that form a part thereof.

Various methods and aspects thereof that can provide processor misspeculation recovery are disclosed. In an aspect, operations performed can include scheduling a consumer instruction, the consumer instruction identifying an operand register and a target register. In an aspect, in association with scheduling the consumer instruction, operations can include retrieving from a memory a dependency vector, the dependency vector identifying a load instruction on which the operand register depends. Operations can also include setting in the memory a target register dependency vector, based on a logical operation on the dependency vector, the target register dependency vector indicating the target register depends on at least the loading instruction on which the operand register depends.

Various apparatuses that can provide for misspeculation recovery by a processor are disclosed. In an aspect, example features can include, in various combinations, a scheduler controller, which may be configured to schedule a loading of a register by a load instruction, and to schedule a consumer instruction, the consumer instruction indicating a set of operand registers and a target register. In an aspect, example features can also include a dependency tracking controller, which can be coupled to the scheduler controller. According to various aspects, the dependency tracking controller can be configured to set in a memory, in association with scheduling the loading of the register by the load instruction, a dependency vector, the dependency vector indicating the register being dependent on the load instruction. In an aspect, the dependency tracking controller can be configured to access the dependency vector, in response to the register being in the set of operand registers, and set in the memory a target register dependency vector, based at least in part on the dependency vector, indicating the target register being dependent on the load instruction.

Various alternative apparatuses that can provide for misspeculation recovery by a processor are disclosed. In an aspect, example features can include, in various combinations, means for scheduling a loading of a register by a load instruction; means for setting a dependency vector for the register, indicating the register having a dependency on the load instruction; means for scheduling a consumer instruction, the consumer instruction indicating a set of operand registers and a target register; and means for setting a dependency vector for the target register, in response to the register being in the set of operand registers, the dependency vector for the target register indicating dependency on the load instruction, and the dependency vector for the target register being based at least in part on the dependency vector for the register.

Various alternative methods and aspects thereof that can provide processor misspeculation recovery are disclosed. In an aspect, operations performed can include :scheduling a loading of a register by a load instruction, assigning to the load instruction a load instruction identifier (ID), and setting in a memory a dependency vector, based at least in part on the load instruction ID and indicating the register being dependent on the load instruction. In an aspect, operations performed can also include scheduling a consumer instruction, the consumer instruction indicating a set of operand registers and indicates a target register. Example operations can also include, upon the register being in the set of operand registers, setting in the memory a dependency vector, at a state based at least on the load instruction ID and indicating the target register being dependent at least on the load instruction.

### BRIEF DESCRIPTION OF THE DRAWINGS

The accompanying drawings are presented to aid in the description of embodiments of the invention and are provided solely for illustration of the embodiments and not limitation thereof.

FIG. 1 is a functional block schematic of a processor arrangement with speculation dependency tracking replay in accordance with various aspects

FIG. 2 shows a flow diagram of example operations in one speculation dependency tracking replay process according to various exemplary aspects.

FIG. 3 illustrates an exemplary wireless device in which one or more aspects of the disclosure may be advantageously employed.

### DETAILED DESCRIPTION

Aspects and features, and examples of various practices and applications are disclosed in the following description and related drawings. Alternatives to disclosed examples may be devised without departing from the scope of disclosed concepts. Additionally, certain examples are described using, for certain components and operations, known, conventional techniques. Such components and operations will not be described in detail or will be omitted, except where incidental to example features and operations, to avoid to obscuring relevant details.

The word “exemplary” is used herein to mean “serving as an example, instance, or illustration.” Any aspect described herein as “exemplary” is not necessarily to be construed as preferred or advantageous over other aspects. In addition, description of a feature, advantage or mode of operation in relation to an example combination of aspects does not require that all practices according to the combination include the discussed feature, advantage or mode of operation.

The terminology used herein is for the purpose of describing particular examples and is not intended to impose any limit on the scope of the appended claims. As used herein, the singular forms “a”, “an” and “the” are intended to include the plural forms as well, unless the context clearly indicates otherwise. In addition, the terms “comprises”, “comprising,”, “includes” and/or “including”, as used herein, specify the presence of stated features, integers, steps, operations, elements, and/or components, but do not preclude the presence or addition of one or more other features, integers, steps, operations, elements, components, and/or groups thereof.

Further, various exemplary aspects and illustrative implementations having same are described in terms of sequences of actions performed, for example, by elements of a computing device. It will be recognized that such actions described can be performed by specific circuits (e.g., application specific integrated circuits (ASICs)), by program instructions being executed by one or more processors, or by a combination of both. Additionally, such sequence of actions described herein can be considered to be implemented entirely within any form of computer readable storage medium having stored therein a corresponding set of computer instructions that upon execution would cause an associated processor to perform the functionality described herein. Thus, the various aspects of implemented in a number of different forms, all of which are contemplated to be within the scope of the claimed subject matter. In addition, for actions and operations described herein, example forms and implementations may be described as, for example, “logic configured to” perform the described action.

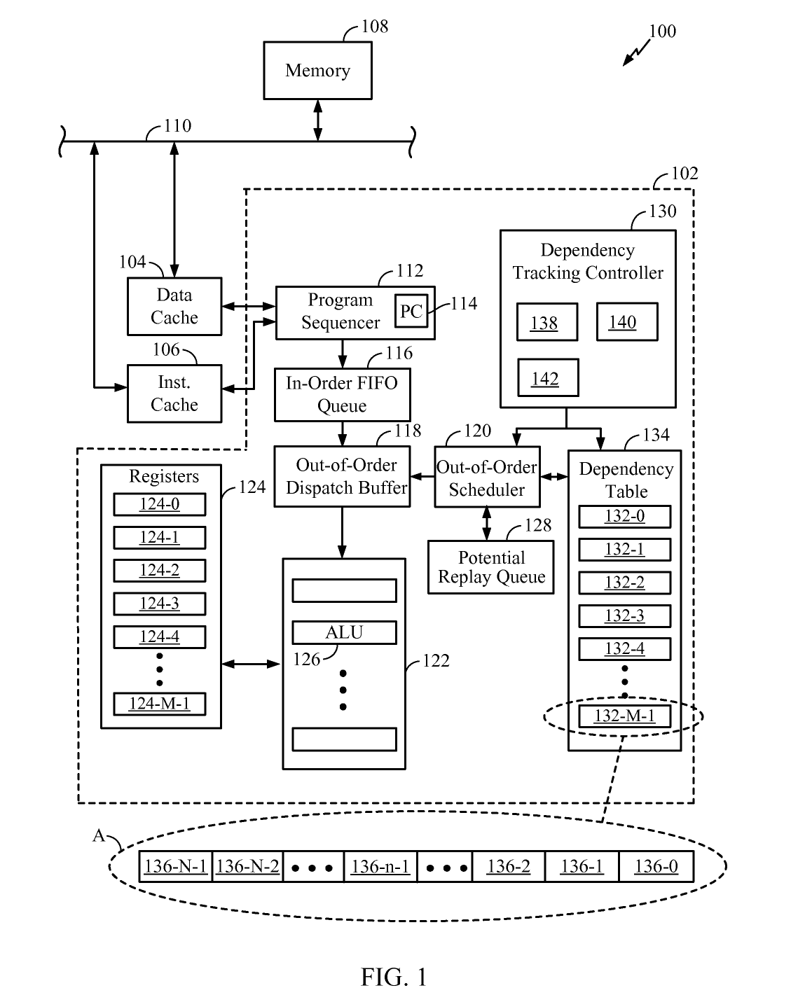

FIG. 1 is a functional block schematic 100 of an example processor system (hereinafter “processor system 100”) that can provide misspeculation recovery in accordance with various aspects.

Referring to FIG. 1 the processor system 100 can include a processor 102, coupled to a data cache 104 and an instruction cache 106, in turn connected to a memory 108 through a bus 110. The processor 102 can include a program sequencer 112, configured to sequence through a program (not explicitly visible in FIG. 1) by fetching instructions (not explicitly visible in FIG. 1) from the instruction cache 106. The program sequencer 112 may include a program counter 114 or equivalent that may append a program count (not explicitly visible in FIG. 1) or other program instruction identifier or program instruction ID to instructions. The processor 102 can include an in-order FIFO (first-in-first-out) queue 116, and an OoO (out-of-order) dispatch buffer 118. An out-of-order (OoO) scheduler 120 can control scheduling of dispatch of instructions from the OoO dispatch buffer 118 to the pipelines 122.

The pipelines 122 of processor 102 can include a plurality of registers 124, comprising a set of M registers such as the example first register 124-0, second register 124-1, third register 124-2, fourth register 124-3, fifth register 124-4 . . . M^{th} register 124-M-1. It will be understood that the arrangement and positioning of the boxes labeled “124,” 124-0,” “124-2,” . . . “124-M-1” is not intended to limit the registers 124 to any particular architecture or relative positioning. It will also be understood that arrangement of the labels “124-0,” “124-2,” . . . “124-M-1” is not intended to limit implementation of the registers 124 to any fixed assignment or mapping. For example, in an aspect the processor 102 may also include a register renaming table (not explicitly visible in FIG. 1. The example quantity of five, i.e., M=5, is only an example, as M can be two, three, five or any other quantity.

The pipelines 122 of processor 102 can also include one or more arithmetic logic units (ALUs), such as the ALU 126. Register selection and communication circuitry (not explicitly visible in FIG. 1) can be included, having functionality that can include selecting, according to ALU instruction parameters, specific pairs of the registers 124 as operand registers for the ALU 126, and a register among the registers 124 as a target register for the result of the ALU instruction. The registers 124 and the ALU 126 can be according to conventional pipeline register and ALU techniques and, therefore, further detailed description of implementation is omitted.

Example operations of the OoO scheduler 120 can include scheduling, for dispatch from the OoO dispatch buffer 118 to the pipelines 122, load instructions to load data into registers 124, and instructions having operand registers among the register 124. Instructions having operand registers among the register 124 will be referred to as “consumer instructions.” The OoO scheduler 120 can be configured to speculatively schedule consumer instructions on the assumption that earlier dispatched load instructions, loading the consumer instruction operand registers, encountered cache hits at the data cache 104. Such speculative scheduling can use conventional speculative scheduling techniques and, therefore, further detailed description is omitted.

Continuing to refer to FIG. 1, the processor 102 may include a potential replay queue 128 that may be coupled, for example, to the OoO scheduler 120. Upon a consumer instruction being speculatively scheduled, the OoO scheduler 120 may be configured to load the consumer instruction into the potential replay queue 128. The potential replay queue 128 can temporarily hold a quantity of consumer instructions (not explicitly visible in FIG. 1) after dispatch from the OoO dispatch buffer 118. As described later in greater detail, each consumer instruction can be held in the potential replay queue until dependencies of the consumer instruction's operand registers on load instructions are resolved either as a cache hit or cache miss.

The data cache 104 and instruction cache 106 may each include cache hit reporting logic (not explicitly visible in FIG. 1) that can send a cache hit notice (not explicitly visible in FIG. 1) upon a cache access instruction encountering a cache hit. The cache hit notice can include identification of the instruction (e.g., data fetch or instruction fetch instruction) that encountered the cache hit. Logic of the processor 102 receiving the cache hit notices can include scheduling circuitry, such as the program sequencer 112 and the OoO scheduler 120, and other logic described in greater detail later.

The data cache 104 and instruction cache 106 may each include cache miss reporting logic (not explicitly visible in FIG. 1) that can send a cache miss notice (not explicitly visible in FIG. 1) upon a cache access instruction encountering a cache miss. The cache miss notice can be received by scheduling logic, such as the program sequencer 112 and OoO scheduler 120, as well as page walk logic (not explicitly visible in FIG. 1), and other logic described in greater detail later. In an aspect, the cache hit reporting logic, cache miss reporting logic, and page walk logic can be in accordance with respective known, conventional techniques.

In an aspect, the processor 102 may include a dependency tracking controller 130. According to various aspects, the dependency tracking controller 130 can be configured to maintain, for each load instruction currently dispatched or scheduled for dispatch from the OoO dispatch buffer 118, information identifying all of the registers 124 that are dependent, directly or indirectly, on that load instruction executing with short latency, i.e., encountering a cache hit. For purposes of description, it will be understood that except where explicitly stated or made clear from the context to have a different meaning, the phrase “load instruction” means a register load instruction that fetches data from a memory location, and when executed first accesses the data cache 104. In an aspect, the dependency tracking controller 130 can be configured to maintain the information identifying the registers 124 that are dependent, directly or indirectly, on one more load instructions as dependency vectors. The dependency tracking controller 130 can be configured to set a dependency vector for each of the registers 124 currently active, and to update the dependency vector upon the OoO scheduler 120 scheduling consumer instructions. Assuming M registers 124, the dependency vectors can be configured as shown by, but are not limited to, the FIG. 1 first dependency vector 132-0, second dependency vector 132-1 . . . and M^{th} dependency vector 132-M-1 (collectively referred to as “dependency vectors 132”). The dependency vectors 132 can be set in a memory that can be coupled to the dependency tracking controller 130. The memory can be, for example, dependency table 134.

In an aspect, each of the dependency vectors 132 can comprise a set of switchable bits, each of the switchable bits being switchable to an ON state. In an aspect, the ON state of each bit can indicate that the register associated with the dependency vector 132 is dependent on a specific load instruction, identified by a position of the switchable bit, which is not yet resolved as a hit/miss. Referring to the FIG. 1 enlarged region A, an example configuration of the set of switchable bits can be the dependency vector first bit 136-0, dependency vector second bit 136-1 . . . dependency vector nth bit 136-n-1 . . . dependency vector nth bit 136-N-1 (collectively referenced in this description as “dependency vector bits 136”) labeled on a representative one of the dependency vectors 132. Each of the dependency vector bits 136 can be switchable between an ON state and an OFF state, e.g., logical “1” and logical “0.” Each of the dependency vector bits 136 that is in the ON state can indicate the register associated with that dependency vector 132 is dependent on a load instruction, identified by the position of the ON bit, which is not yet resolved as a hit/miss. The quantity N can correspond to the quantity N described above, which is a maximum number of scheduled, not yet resolved register load instructions that may be concurrently outstanding during execution of a program by the processor 102.

The dependency tracking controller 130 can be further configured to set a dependency vector 132 upon the OoO scheduler 120 scheduling a consumer instruction identifying an operand register and a target register. Operations of the dependency tracking controller 130 can include, in association with scheduling the consumer instruction, retrieving from a memory (e.g., the dependency table 134) the dependency vector 132 for each of the consumer instruction's operand registers. The dependency vector 132 for each of the consumer instruction's operand registers, or at least each of the operand registers having any current dependency on load instructions, in an aspect, can have already been set in the dependency table 134. For example, the setting may have been in association with earlier scheduling of load instructions for loading the operand registers with data, as will be later described in greater detail. Alternatively, the dependency vector(s) 132 for the operand registers may have been set (such as currently being described); in association with earlier scheduling of consumer instructions having, as their respective target registers, the current consumer instruction's operand registers. Example operations of the dependency tracking controller 130 and OoO scheduler 120 can include setting in the memory (e.g., the dependency table 134) a target register dependency vector, based on a logical operation on the dependency vector for each of the operand registers, or at least the operand registers having any dependency. The logical operation, in an aspect, can set the dependency vector 132 for the target register to a state indicating the target register depends on at least the loading instruction(s) on which the operand register(s) depends( ).

As described above, the dependency tracking controller 130 can be configured to maintain an association of each valid dependency vector 132 with a corresponding register 124. The association can be maintained, for example, in a mapping table 138. The mapping table 138 can be implemented, for example, as an adaptation of a conventional register renaming table. In an aspect, the dependency tracking controller 130 and a load instruction identifier pool 140 can be configured to perform as a means for assigning to the load instructions a load instruction identifier (ID), upon scheduling by the OoO scheduler 120. For example, the dependency tracking controller 130 may be configured to hold, or to be loadable with a load instruction identifier pool 140. The load instruction identifier pool 140 can be configured to hold, for example, upon an initialization or reset, a pool of N load instruction IDs (not explicitly visible in FIG. 1). The quantity N can be, or can establish, a maximum number of concurrently unresolved load instructions on which consumer instructions can be speculatively scheduled by the OoO scheduler 120.

In an aspect, the load instruction identifier pool 140 can hold the N load instruction IDs as a pool of N load instruction ID bit positions. The N load instruction ID bit positions can correspond to the bit positions of the dependency vector bits 136 described. The dependency tracking controller 130 and the load instruction identifier pool 140, in an aspect, can be co-operatively configured to assign each load instruction ID as a load instruction ID bit position, taken from the unassigned bit positions currently in the load instruction identifier pool 140. In an aspect, the dependency tracking controller 130 may be configured to recover the assigned load instruction ID, e.g., the assigned load ID bit position, upon the scheduled load instruction being resolved, as a cache hit or as a cache miss respectively.

In an aspect, a program instruction ID (identifier) (not explicitly visible in

FIG. 1) can be appended to load instructions and to consumer instructions. The program instruction IDs, in an aspect, can be according to conventional program counter techniques, such as program counter values (not explicitly visible in FIG. 1).

In an aspect, the dependency tracking controller 130 can be configured with, or to have access to, a load ID assignment list 142. The dependency tracking controller 130 can be configured to perform as means for storing an assignment record, the assignment record comprising the load instruction ID and the program instruction ID, and the assignment record being stored according to, and accessible based on the program instruction ID. For example, the load ID assignment list 142 can be configured to hold an assignment record (not explicitly visible in FIG. 1) that maps each assigned load instruction ID to the program instruction ID of the load instruction to which it is assigned. The load ID assignment list 142, for example, can be an index between the program instruction ID of each unresolved, scheduled load instruction and its assigned load instruction ID. The term “list,” in the context of the phrase “load ID assignment list” used in this description, is not intended to limit the scope of “load ID assignment list,” for example, to arrangements within the ordinary meaning of “list.”

As described above, the dependency tracking controller 130 can be configured to assign each load instruction ID as a load instruction ID bit position, from a set of N bit positions for assignment. The assignment corresponds to one of the N bit positions of the dependency vector bits 136. In a cooperative aspect, the dependency tracking controller 130, in association with scheduling a load instruction having an assigned load instruction nth ID bit position, can set the nth bit (e.g., the dependency vector nth bit 136-n-1) of the dependency vector 132 of the load register at an ON state.

In an aspect, upon each scheduling of a consumer instruction, the dependency tracking controller 130 can access, for example, in the dependency table 134, the dependency vector 132 for each of the operand registers (among the registers 124) of the consumer instruction. The dependency tracking controller 130 can be configured to set the dependency vector 132 for the target register by switching to an ON state the dependency vector nth bit 136-n-1 of the dependency vector 132 for each target register having any operand register (among the registers 124) that, in turn, has a register dependency vector 132 having an ON state of its the dependency vector nth bit 136-n-1. Accordingly, the dependency tracking controller 130 can set the N dependency vector bits 136 of the dependency vector 132 of the target register (among the registers 124) as an accumulation of the N dependency vector bits 136 of each of dependency vector 132 for each of its operand registers (among the registers 124).

Example operations of the FIG. 1 processor system 100 in a process of tracking register dependency in accordance with various aspects will be described. The example can include scheduling, for example, by the OoO scheduler 120, load instructions for loading a first register and a second register, followed by speculative scheduling a consumer instruction having the first register and the second register as operand registers. The first load instruction can be, for example, to load the first register 124-0 with a first data at a first memory location. The second load instruction can be, for example, to load the second register 124-1, with a second data at a second memory location. The OoO scheduler 120 can assume, in speculative scheduling the consumer instruction having the first register and the second register as operand registers, that the first data and the second data are each in the data cache 104.

In the example process, the dependency tracking controller 130 can assign to the first load instruction a first load instruction ID, and to the second load instruction a second load instruction ID. The dependency tracking controller 130 can assign the first load instruction ID and second load instruction ID, as described above, as a load instruction first ID position, and the load instruction second ID position can be, for example, from the load instruction identifier pool 140. As to contents of the load instruction identifier pool 140 at the time of the described assignment, it will be assumed that all N bit positions are available. For example, a reset or initialization may have been applied to the load instruction identifier pool 140. Therefore the load instruction first ID position and the load instruction second ID position may be a first bit position and a second bit position, respectively, among the N bit positions.

In an aspect, in association with scheduling the first load instruction, the dependency tracking controller 130 can set a first dependency vector, for example, the first register dependency vector 132-0, in the dependency table 134. In like aspect, in association with scheduling the second load instruction, the dependency tracking controller 130 can set a second dependency vector, for example, the second register dependency vector 132-1, in the dependency table 134. As described above, the first dependency vector and the second dependency vector can each comprise N bits. Since dependency tracking controller 130 has assigned the load instruction first ID position and the load instruction second ID position, N may be at least two.

In an aspect, the first dependency vector and the second dependency vector can have the same correspondence between their bit positions and the load instruction's first bit ID position and second ID bit position. For example, the first dependency vector can comprise a first dependency vector first bit, and the second dependency vector can comprise a second dependency vector first bit, each corresponding to the load instruction first ID bit position. The first dependency vector first bit can be the dependency vector first bit 136-0 of the first dependency vector 132-0. The second dependency vector first bit can be the dependency vector first bit 136-0 of the second dependency vector 132-1. The first dependency vector can, similarly, comprise a first dependency vector second bit, and the second dependency vector can comprise a second dependency vector second bit, each corresponding to the load instruction second ID bit position. The first dependency vector second bit can be the dependency vector second bit 136-1 of the first dependency vector 132-0. The second dependency vector second bit can be the dependency vector second bit 136-1 of the second dependency vector 132-1.

In an aspect, the dependency tracking controller 130 can be configured to generate, in association with the speculative scheduling the consumer instruction having the first register and the second register as operand registers, a dependency vector for the target register. For purposes of description, the dependency vector for the target register, in this context, can be referred to a “target register dependency vector.” Generation of the target register dependency vector, in an aspect, can comprise a logical OR of the dependency vector for the first operand register with the dependency vector for the second operand register. The logical OR can comprise a logical OR of the first dependency vector first bit and the second dependency vector first bit, and a logical OR of the first dependency vector second bit and the second dependency vector second bit. The logical OR operations can generate the dependency vector for the target register having a dependency vector first bit at the ON state and a dependency vector second bit at the ON state. This can be an example of a “target register dependency vector first bit” being in an ON state and a “target register dependency vector second bit” being in an ON state.

The ON state of the dependency vector first bit of the dependency vector for the target register (i.e., the target register dependency vector first bit) indicates the target register being dependent on the first load instruction. The ON state of the dependency vector second bit of the dependency vector for the target register (i.e., the target register dependency vector second bit) indicates the target register being dependent on the second load instruction.

In an aspect, the dependency tracking controller 130 can be configured to initialize, prior to the operations described above, the set of M dependency vectors 132, including the first dependency vector 132-0 and the second dependency vector 132-1 described above. The initializing can, for example, to all N bits of the first dependency vector 132-0 and the second dependency vectors to an OFF state, e.g., binary “0.” Each of the above-described settings of the first dependency vector 132-0 and the second dependency vector 132-1 set only one bit of each to an ON state. The other bit(s) can be left in the OFF state. Accordingly, the operations of setting the first dependency vector 132-0 can place the first dependency vector 132-0 in a state indicating dependence on the first load instruction and independence from the second load instruction. The operations of setting the second dependency vector 132-1 can likewise place the second dependency vector 132-1 in a state indicating dependence on the second load instruction and independence from the first load instruction. In an aspect, operations can include an OFF state of the dependency vector second bit 136-1 of the first dependency vector 132-0, indicating the first operand register being independent of the second load instruction. Operations can also include an OFF state of the dependency vector first bit 136-0 of the second dependency vector 132-1, indicating the target register being independent of the first load instruction.

Referring to FIG. 1 and to Table 1 below, operations in a process of tracking register dependency in another speculative scheduling sequence, and related misspeculation recovery in accordance with various aspects will be described. Referring to Table 1, the Table 1 term “R0” means “first register,” which can correspond to or be, for example, the first register 124-0 on FIG. 1. The Table 1 terms “R1,” “R2,” “R3,” and “R4” mean, respectively, “second register,” “third register,” “fourth register” and “fourth register”, and can be respective examples of the FIG. 1 second register 124-1, third register 124-2, fourth register 124-3, and fifth register 124-4. For brevity, the term “register RX” will be used to collectively reference R0, R1, R2 and R3.

For convenience in description and illustration, the phrase “dependency vector” will be alternatively referenced by the arbitrary label “RD.” The Table 1 term “RD(R0)” means “first register dependency vector,” in other words, the dependency vector for the first register R0, and can be an example of the FIG. 1 first register dependency vector 132-0. The Table 1 “RD(R1)” means “second register dependency vector,” in other words, the dependency vector for the second register R1, and can be an example of the FIG. 1 second register dependency vector 132-1. The Table 1 “RD(R2)” and “RD(3),” respectively, mean “third register dependency vector” and “fourth register dependency vector,” i.e., the dependency vector for the third register R2 and the dependency vector for the fourth register R3. RD(R2) and RD(3), can be respective examples of the FIG. 1 third register dependency vector 132-2 and fourth register dependency vector 132-3. The Table 1 “RD(R4)” means “fifth register dependency vector,” in other words, the dependency vector for the fifth register R4, and can be an example of the FIG. 1 fifth register dependency vector 132-4. For brevity, the term “dependency vector RD(RX)” will be used to collectively reference RD(R0), RD(R1), . . . and RD(R4).

Table 1 shows an arbitrarily selected scheduling sequence of instructions “I1,” “I2,” “I3,” “I4,” and “I5,” hereinafter “instructions “I1-I5.” The labels “I1-I5,” can represent, for example, program instruction IDs, for example, program counter values appended to the instructions I1-I5. The instructions I1-I5 may have been fetched, for example, from the instruction cache 106 under control of the program sequencer 112.

TABLE 1

| Inst. ID | Instruction - | RD(R0) | RD(R1) | RD(R2) | RD(R3) | RD(R4) |
|---|---|---|---|---|---|---|
| Initialize | None | Null | Null | Null | Null | Null |
| I1 | LDR: R0, [R13, #0] | L1 | Null | Null | Null | Null |
| | Assign Load ID = L1 | | | | | |
| I2 | LDR: R1, [R13, #4] | L1 | L2 | Null | Null | Null |
| | Assign Load ID = L2 | | | | | |
| I3 | ADD R2, R2, R0 | L1 | L2 | L1 | Null | Null |
| I4 | ADD R3, R3, R1 | L1 | L2 | L1 | L2 | Null |
| I5 | ADD R4, R3, R2 | L1 | L2 | L1 | L2 | L1, L2 |

An example N quantity of sixteen is used, meaning that each of the register dependency vectors RX can indicate its corresponding register being concurrently dependent on up to sixteen unresolved load instructions. Referring to the first row of Table 1 (meaning the first row directly following the header row) operations can begin by initializing RD(R0), RD(R1) . . . RD(R4), for example, setting each to a “null” state. The null state, as described above, can correspond to all N bits of each register dependency vector RD being at an OFF state, e.g., at binary “0.” The initialization can therefore set each of the register dependency vectors RD to binary “0000_0000_0000_0000.” Associated with the initialization, dependency tracking controller 130 may set all its load instruction IDs (not explicitly visible in FIG. 1) to an unassigned state. In other words, all sixteen (in this example) bit positions can be available for associating with a register load instruction.

Next, as shown by the second row and third row of Table 1, the OoO scheduler 120 can schedule the first load instruction I1 and the second load instruction I2. The first load instruction I1, when executed, will first access the data cache 104, and look for data at the memory location “#0.” Similarly, the second load instruction I2, when executed, will first access the data cache 104, and look for data at the memory location “#4.” Associated with scheduling the first load instruction I1, the dependency tracking controller 130 can assign “L1” to the first load instruction, as a first load instruction ID. L1 may be a load instruction first ID bit position. L1 can be, for example, the rightmost of the sixteen bit positions. Associated with scheduling the second load instruction I2, the dependency tracking controller 130 can assign it a second load instruction ID of “L2.” L2 can be, for example, a second of the sixteen bit positions, for example, one bit position to the left of the load instruction first ID bit position.

Associated with scheduling the first load instruction I1 the dependency tracking controller 130 can set the first register dependency vector RD(R0) to the binary value “0000_0000_0000_0001.” Table 1 represents RD(R0) at the binary value “0000_0000_0000_0001” as “L1” because the bit of the first register dependency vector RD(R0) corresponding L1, the load instruction first ID bit position, is at an ON state. Associated with scheduling the second load instruction I2, the dependency tracking controller 130 can set the second register dependency vector RD(R1) to the binary value “0000_0000_0000_0010.” Table 1 represents RD(R1) at the binary value “0000_0000_0000_0010” as “L2” because the bit of the second register dependency vector RD(R1) corresponding to L2, meaning the load instruction second ID bit position, is at an ON state. Referring to FIG. 1, the scheduling of the second load instruction I2 does not change the first register dependency vector RD(R0). Similarly, neither the scheduling of the first load instruction I1 nor the scheduling of the second load instruction I2 changes any of the third register dependency vector RD(R2), the fourth register dependency vector RD(R3), or the fifth register dependency vector RD(R4), all remaining at their initialized “null” state of “0000_0000_0000_0000.”

Referring to the third row of Table 1, the OoO scheduler 120 can next schedule, as an example consumer instruction, a first ADD instruction I3. The first ADD instruction I3 identifies, as operand registers, the first register R0 and the third register R2. The first register R0 and the third register R2, in this context, can be referred to as “instruction set of operand registers.” The first ADD instruction I3 identifies as a target register the third register R2. The third register R2, in this context, can be referred to as an “instruction target register.” The dependency tracking controller 130 can, in association with scheduling the first ADD instruction, first access (e.g., read or scan) the register dependency vector of each of the first instruction operand registers. The dependency tracking controller 130 therefore operates, for example, on the dependency table 134, to access the first register dependency vector RD(R0) and the third register dependency vector RD(R2). The dependency tracking controller 130 can then logically operate on the respective register dependency vectors for the instruction operand registers, namely, the first register dependency vector RD(R0) and the third register dependency vector RD(R2).

A result of the logical operation described above is, upon the first register R0 being in the set of instruction operand registers, setting in a memory (e.g., the dependency table 134, a dependency vector (e.g., the third register dependency vector RD(R2), at a state based at least on the first load instruction ID and indicating the instruction target register being dependent at least on the first load instruction.

In an aspect, the above-described logical operation on the dependency vectors for the first instruction operand registers, i.e., on the first register dependency vector RD(R0) and the third register dependency vector RD(R2) can be a logical OR. In the present example, the third register dependency vector RD(R2) has not been updated since it was initialized. The logical OR of the first register dependency vector RD(R0) and the third register dependency vector RD(R2) can therefore be binary “0000_0000_0000_0000” logically OR' d with binary “0000_0000_0000_0001.” The result is that bit of the register dependency vector for the first instruction target register that is ON corresponds to the bit position assigned as an ID to the first load instruction, namely, the rightmost bit, which is the load instruction first ID bit position. The register dependency vector for the first instruction target register is therefore set at a state, shown in Table as “L1,” that at identifies an accumulation of the respective dependencies of all of the first operand registers, and is based at least in part on the first load instruction ID.

Referring to the fourth row of Table 1, the OoO scheduler 120 can next schedule, as an example second consumer instruction, a second ADD instruction I4. The second ADD instruction I3 identifies, as operand registers, the second register R1 and the fourth register R3, and identifies the fourth register R3 as the target register. The second register R1 and the fourth register R3, in this context, can be referred to as “second instruction operand registers.” The fourth register R3, in this context, can be referred to as “second instruction target register.” The dependency tracking controller 130, in association with scheduling the second ADD instruction I4, can first access (e.g., read or scan the dependency table 134) the register dependency vector of each of the second operand registers. The dependency tracking controller 130 can then logically operate, e.g., logically OR the second instruction operand registers' dependency vectors, namely, the second register dependency vector RD(R1) and the fourth register dependency vector RD(R3). The fourth register dependency vector RD(R3) has not been updated since it was initialized. The logical OR of the second register dependency vector RD(R1) and the fourth register dependency vector RD(R3) is binary“0000_0000_0000_0010” logically OR'd with binary “0000_0000_0000_0000.” The result is that the bit of the register dependency vector for the second target register that is ON corresponds to L2, the bit position assigned as an ID to the second load instruction, namely, the rightmost bit. The dependency vector for the second instruction target register is therefore at a state that identifies an accumulation of the respective dependencies of all of the second instruction operand registers, and that is based at least in part on the second load instruction ID.

It can be understood that a result of the above-described logical operation is that, upon the second register R1 being in the second instruction set of operand registers, setting in the memory a dependency vector for the second instruction target register, at a state based at least on the second load instruction ID and indicating the second instruction target register being dependent at least the second load instruction.

Next the OoO scheduler 120 schedules a third consumer instruction, for this example, a third ADD instruction I5. The third ADD instruction I5 operand registers are the third register R2 and the fourth register R3, and its target register is the fifth register R4. The third register R2 and the fourth register R3, in this context, can be referred to as “third instruction operand registers.” The fifth register R4, in this context, can be referred to as “third instruction target register.” Associated with the scheduling, the dependency tracking controller 130 can first perform a read of the dependency table 134 to access of the dependency vectors for the third ADD instruction IS operand registers, i.e., RD(R2) and RD(R3). The dependency tracking controller 130 can then logical OR the bits that form the third register dependency vector RD(2) and the bits that form the fourth register dependency vector RD(R3), to obtain an accumulated dependency vector for of its target register R4. The third register dependency vector was updated by the first ADD instruction I3 to “L1.” The fourth register dependency vector, RD(R3), was updated by the second ADD instruction I4 to “L2.” The logical OR of the third register dependency vector RD(R2) and the fourth register dependency vector RD(R3) is therefore L1 OR'd with L2 (i.e., “0000_0000_0000_0001” OR' d with “0000_0000_0000_0010”), producing binary “0000_0000_0000_0011.” The dependency vector for the third target register is therefore at a state, represented in Table 1 as “L1,L2,” that identifies an accumulation of the respective dependencies of all of the third ADD instruction I5 operand registers.

It can be understood that a result of the above-described logical operation is that, upon the first instruction target register and the second instruction target register being in the third instruction set of operand registers, setting the dependency vector for the third instruction target register based at least on the dependency vector for the first instruction target register and the dependency vector for the second instruction target register, and indicating the third instruction target register being dependent at least on the first load instruction and on the second load instruction.

Upon a subsequent consumer instruction having the fifth register R4 as one of its operand registers being scheduled, the dependency tracking controller 130 can first read the dependency vector for the fifth register, RD(R4), in the dependency table 134, as well as the dependency vector for any other of the subsequent consumer instruction's operand registers. The dependency tracking controller 130 can then logically OR the bits that form the dependency vector for the fifth register, RD(R4), with the bits (not necessarily visible in Table 1) forming the register dependency vector for any other operand register(s) of the subsequent consumer instruction. The subsequent consumer instruction and can therefore carry forward to the bits forming the dependency vector for its target register (not necessarily visible in Table 1) a state that includes the dependency chain indicated by the first load instruction ID L1 and the second load instruction ID L2 that are accumulated in the bits that form the fifth register dependency vector RD(R4). The above-described example dependency chain can continue to build as additional consumer instructions are scheduled, until the first load instruction I1 and second load instructions 12 resolve as a cache hit/miss.

In an aspect, upon notice of a cache hit associated, for example, with the first load instruction I1, the dependency tracking controller 130 can access, for example, the load ID assignment list 142 and obtain L1, the bit position that was assigned as a load instruction ID to the first load instruction. The dependency tracking controller 130 can then access all of the dependency vectors 132 in the dependency table 134 and reset to an OFF state, e.g., logical “0,” the bit in each that corresponds to L1. The dependency tracking controller 130 can also return the L1 bit position to the load instruction identifier pool 140. Similar operations can be performed when the second load instruction I2 resolves to a cache hit. For example, upon notice of a cache hit associated with the second load instruction I2, the dependency tracking controller 130 can access the load ID assignment list 142 and obtain L2, the bit position that was assigned as a load instruction ID to the second load instruction. The dependency tracking controller 130 can then access all of the dependency vectors 132 in the dependency table 134 and reset to an OFF state, e.g., logical “0,” the dependency vector bit in each that corresponds to L2. The dependency tracking controller 130 can also return the L2 bit position to the load instruction identifier pool 140.

In an aspect, the dependency tracking controller 130, OoO scheduler 120, potential replay queue 128, dependency table 134, load instruction identifier pool 140 and load ID assignment list 142 can be configured to perform as a means for retrieving the dependency vector for the target register for each consumer instruction in the potential replay queue 128, upon receiving a cache miss notice associated with a load instruction. In another aspect, the OoO scheduler 120, the potential replay queue 128 the dependency tracking controller 130, and the potential replay queue 128 can be configured to perform as a means for scheduling a replay of the consumer instruction, based at least in part on the dependency vector for the target register.

For example, in an aspect, upon the first load instruction I1 resolving to a cache miss, a notice of cache miss associated with the first load instruction I1 can be broadcast. The dependency tracking controller 130, upon receiving the notice of cache miss associated with the first load instruction I1, can read the dependency table 134 to identify all consumer instructions, e.g., the first ADD instruction and the third ADD instructions that depend from that first load instruction I1. The dependency tracking controller 130 can then notify or report to OoO scheduler 120 the load instruction IDs of all such consumer instructions. The OoO scheduler 120 can then retrieve all such consumer instructions from the potential replay queue 128 for replay. Similar operations can be performed when the second load instruction I2 resolves to a cache miss. For example, upon the second load instruction I2 resolving to a cache miss, a notice of cache miss associated with the second load instruction I2 can be broadcast. The dependency tracking controller 130, in response, can read the dependency table 134 to identify all consumer instructions, e.g., the second ADD instruction and the third ADD instructions that depend from that second load instruction I2. The dependency tracking controller 130 can then notify or report to OoO scheduler 120 the load instruction IDs of all such consumer instructions, and the OoO scheduler 120, in response, can retrieve all such consumer instructions from the potential replay queue 128 for replay

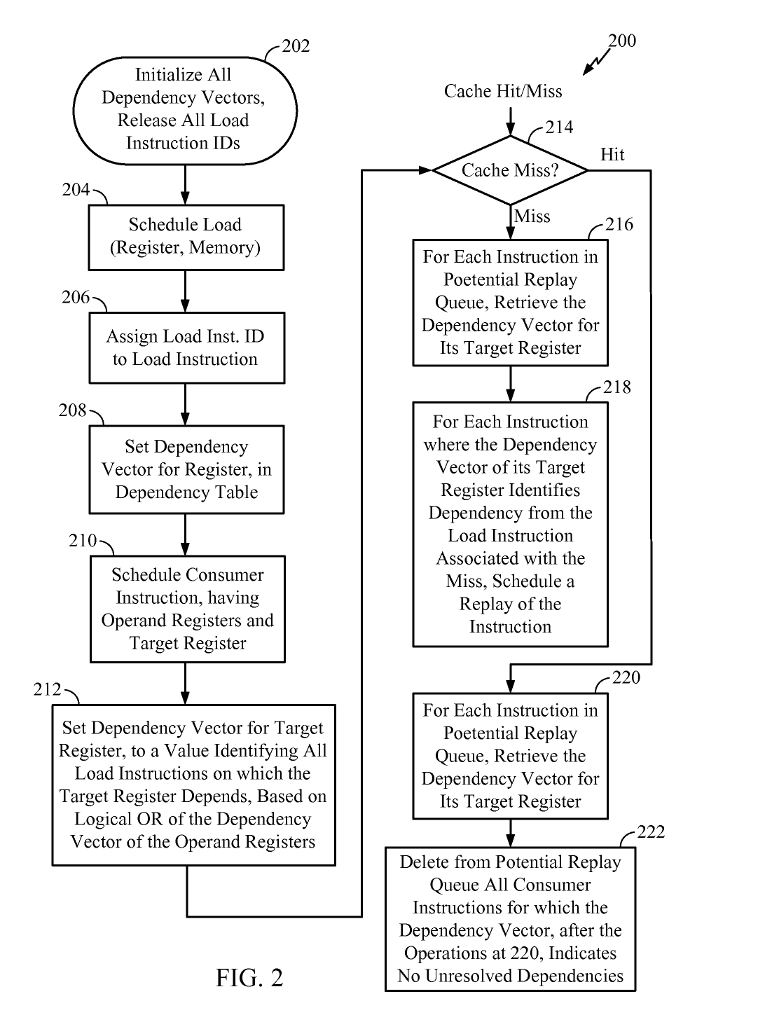

FIG. 2 shows a flow diagram 200 (hereinafter “flow 200”) of example operations in one speculation dependency tracking replay process according to various exemplary aspects. Referring to FIG, 2, the flow can start at 202 with initializing all of the dependency vectors, and release all of the load instruction IDs. For example, referring to FIG. 1, and assuming M registers 124 and a set of N 16-bit instruction load IDs, operations at 202 can set the M dependency vectors 132 to “0000_0000_0000_0000.” In an aspect, the flow 200 can proceed to 204 and apply operations of scheduling a load instruction. The load instruction can be, for example, a loading of a first register among the registers. For example, referring to FIG. 1 and to Table 1, operations at 204 can include the OoO scheduler 120 scheduling the first load instruction I1. In an aspect, the flow 200 can proceed to 206 and apply operations of assigning to the load instruction an identifier. For example, referring to FIG. 1 and Table 1, example operations at 206 can include the dependency tracking controller 130 assigning a first load instruction ID to the load instruction. The assignment can include, for example, assigning a specific bit of N (in this example N is equal to sixteen) to the load instruction.

Referring to FIG. 2, in association with operations at 204 and 206, the flow 200 can proceed to 208 and apply operations of setting in a register dependency memory (e.g., the dependency table 134) a first register dependency entry, corresponding to the first register, to a value identifying the register load instruction. For example, referring to FIG. 1 and Table 1, examples of operations at 208 can include the dependency tracking controller 130 setting, in the dependency table 134, the first register dependency vector RD(R0) to the L1 state that identifies the first register R0 as dependent on the first load instruction I1.

Referring to FIG. 2, it will be understood that sequential order of describing the blocks, e.g., blocks 204, 206 and 208 is not necessarily restrictive of an order of the operations. For example, one or more operations at 206 and 208 and elsewhere can be concurrent, or can be performed in an order other than the ordering of the blocks.

Continuing with the flow 200, after operations at 208 of setting in the memory the first register dependency vector RD(R0), the flow 100 can proceed to 210 and apply operations of scheduling a consumer instruction. Referring to FIG. 1 and Table 1, an example of operations at 210 can include the OoO scheduler 120 scheduling the first ADD instruction I3. Operations in the flow 200 can then proceed to 212 (or perform operations at 212 concurrent with operations at 210) and apply operations for setting, in the register dependency memory, a dependency vector for the target register, to a value identifying all load instructions on which the target register depends. In an aspect, operations at 212 can be based at least in part, on dependency vectors of the operand registers. Referring to FIG. 1 and Table 1, example operations at 212 can include the dependency tracking controller 130 updating the third register dependency vector RD(R2) in association with the OoO scheduler 120 scheduling the first ADD instruction I3. As described, the operation can be a logical OR of the dependency vectors for the operand registers (R0 and R2) of the first ADD instruction. Referring again to FIG. 1 and Table 1, another example of operations at 212 can include the dependency tracking controller 130 updating the fourth register dependency vector RD(R3) in association with the OoO scheduler 120 scheduling the second ADD instruction I4. As described, the operation can be a logical OR of the dependency vectors for the operand registers (R1 and R3) of the second ADD instruction. Another example of operations at 212 can include the dependency tracking controller 130 updating the fifth register dependency vector RD(R4) in association with the OoO scheduler 120 scheduling the third ADD instruction I5. As described, the operation can be a logical OR of the respective dependency vectors for the operand registers (R2 and R3) of the third ADD instruction.

In an aspect, after operations at 212 the flow 200 can, in response to receiving a cache miss notice at 214, proceed to 216. At 216 the flow 200 can apply operations of retrieving, from the dependency table 134, for each consumer instruction in the potential replay queue 128, the dependency vector 132 for its target register. The flow 200 can then proceed to 218 and, for each consumer instruction in the potential replay queue 128 where the dependency vector identifies dependency from the load instruction associated with the miss, the flow 200 can apply operations of scheduling a replay of that consumer instruction.

Referring to FIG. 2, in response to receiving a cache hit notice at 214, the flow 200 can proceed to 220 and update all of the dependency vectors to remove indication of dependency from the load instruction that is associated with the hit. The flow 200 can then proceed to 222 and delete from the potential replay queue 128 all consumer instructions for which the dependency vector for its target register, after the operations at 220, indicate no unresolved dependencies. In an aspect, operations at 222 can include returning to the load instruction identifier pool 140 the bit position that was assigned to the load instruction associated with the hit. Referring to Table 1, example operations at 220 can include, in response to receiving notice that the first load instruction I1 resolved as a hit, accessing the load ID assignment list 142 and obtaining the bit position that was assigned as a load instruction ID to the first load instruction I1. Operations can further include the dependency tracking controller 130 accessing all of the dependency vectors 132 in the dependency table 134 and resetting to an OFF state, e.g., logical “0,” the dependency vector bit 136 in each that corresponds to the assigned bit position. The dependency tracking controller 130 can also return the bit position to the load instruction identifier pool 140. Similar operations can be performed when the second load instruction I2 resolves to a cache hit.

In one example alternative process according to the flow 200, operations can start at 210, assuming the operand registers have already been loaded, and the dependency vectors for each of the operand registers have already been set, according to disclosed aspects.

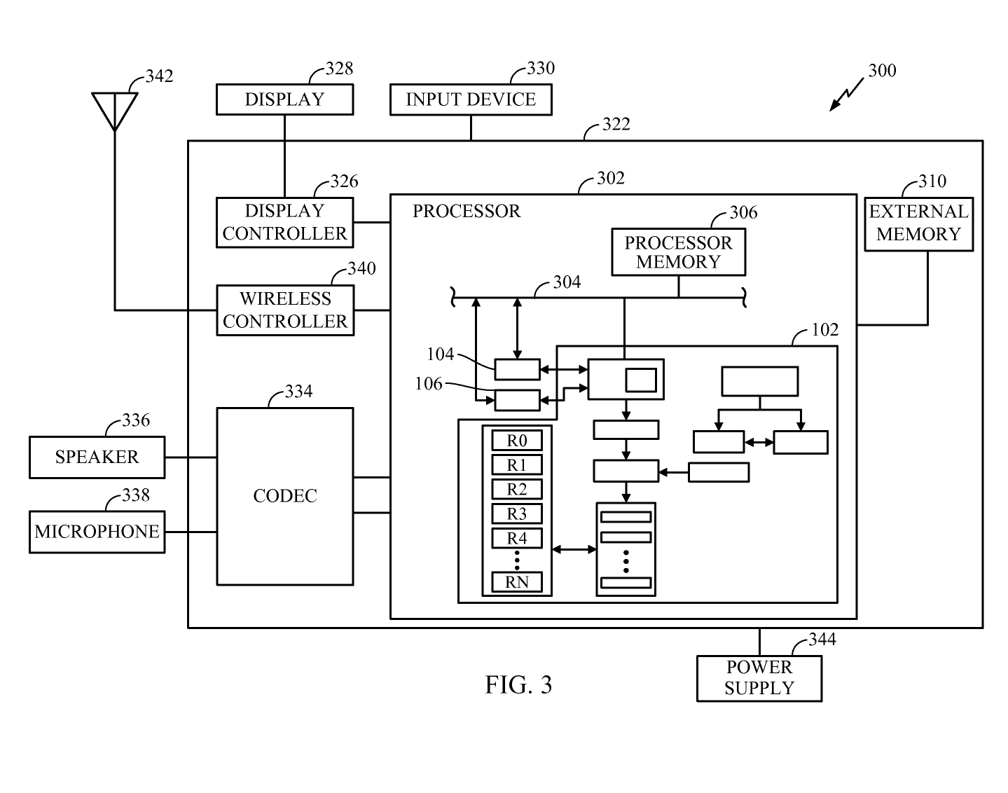

FIG. 3 illustrates a wireless device 300 in which one or more aspects of the disclosure may be advantageously employed. Referring now to FIG. 3, wireless device 300 includes processor device 302, comprising the processor 102 and, connected to a processor memory 306 by a processor bus 304 the data cache 104 and instruction cache 106. The processor memory 306 may be according to the FIG. 1 memory 108. The processor bus 304 may be according to the FIG. 1 bus 110. The processor 102 may be configured to provide speculation dependency tracking, and replay according to various aspects disclosed herein. The processor 102 may be configured as described in reference to FIG. 1, and may be configured to perform any method, for example, as described in reference to Table 1 and/or FIG. 2. The processor device may be further be configured to execute instructions, for example, on the processor 102 retrieved from processor memory 306, or external memory 310 in order to perform any of the methods described in reference to FIG. 1, or Table 1, and/or FIG. 2.

FIG. 3 also shows display controller 326 that is coupled to processor device 302 and to display 328. Coder/decoder (CODEC) 334 (e.g., an audio and/or voice CODEC) can be coupled to processor device 302. Other components, such as wireless controller 340 (which may include a modem) are also illustrated. For example, speaker 336 and microphone 338 can be coupled to CODEC 334. FIG. 3 also shows that wireless controller 340 can be coupled to wireless antenna 342. In a particular aspect, processor device 302, display controller 326, external memory 310, CODEC 334, and wireless controller 340 may be included in a system-in-package or system-on-chip device 322.

In a particular aspect, input device 330 and power supply 344 can be coupled to the system-on-chip device 322. Moreover, in a particular aspect, as illustrated in FIG. 3, display 328, input device 330, speaker 336, microphone 338, wireless antenna 342, and power supply 344 are external to the system-on-chip device 322. However, each of display 328, input device 330, speaker 336, microphone 338, wireless antenna 342, and power supply 344 can be coupled to a component of the system-on-chip device 322, such as an interface or a controller.

It should also be noted that although FIG. 3 depicts a wireless communications device, the processor device 302, comprising processor 102, processor bus 304, processor memory 306, data cache 104 and instruction cache 106, may also be integrated into a set-top box, a music player, a video player, an entertainment unit, a navigation device, a personal digital assistant (PDA), a fixed location data unit, a computer, a laptop, a tablet, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, implementations and practices according to the disclosed aspects can include a computer readable media embodying a method for de-duplication of a cache. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for processor load latency misspeculation recovery, comprising:
scheduling a consumer instruction which identifies an operand register and a target register; and
in association with scheduling the consumer instruction,
retrieving from a memory a dependency vector, the dependency vector identifying a load instruction on which the operand register depends, and
setting in the memory a target register dependency vector, based on a logical operation on the dependency vector, the target register dependency vector indicating the target register depends on at least the load instruction on which the operand register depends.

2. The method of claim 1, the operand register being a first operand register, the dependency vector being a first dependency vector, and the consumer instruction further identifying a second operand register, the method further comprising:
in association with scheduling the consumer instruction, also retrieving a second dependency vector, the second dependency vector identifying a load instruction on which the second operand register depends, the logical operation being a logical operation on the first dependency vector and on the second dependency vector.

3. The method of claim 2, the logical operation on the first dependency vector and on the second dependency vector being configured to set the target register dependency vector to indicate that the target register depends on an accumulation of at least the load instruction on which the first operand register depends and the load instruction on which the second operand register depends.

4. The method of claim 2, further comprising:
scheduling a loading of the first operand register by a first load instruction, the first load instruction being the load instruction on which first operand register depends; and
scheduling a loading of the second operand register by a second load instruction, the second load instruction being the load instruction on which second operand register depends.

5. The method of claim 4, further comprising:
in association with scheduling the first load instruction, assigning to the first load instruction a first load instruction identifier (ID), the first load instruction ID being from a pool of N load instruction IDs; and
in association with scheduling the second load instruction, assigning to the second load instruction a second load instruction ID, the second load instruction ID being from the pool of N load instruction IDs.

6. The method of claim 5, the first dependency vector being based, at least in part, on the first load instruction ID, and indicating the first operand register being dependent on the first load instruction, and the second dependency vector being based, at least in part, on the second load instruction ID, and indicating the second operand register.

7. The method of claim 6, the first load instruction ID being a load instruction first ID bit position, the second load instruction ID being a load instruction second ID bit position.

8. The method of claim 7, the logical operation on the first dependency vector and on the second dependency vector, the logical operation generating the target register dependency vector to include a dependency vector first bit and a dependency vector second bit, the dependency vector first bit being at a first bit position, the first bit position corresponding to the load instruction first ID bit position, the dependency vector second bit being at a second bit position, the second bit position corresponding to the load instruction second ID bit position.

9. The method of claim 8, the logical operation on the first dependency vector and on the second dependency vector being configured to generate the target register dependency vector to indicate that the target register depends on an accumulation of at least the load instruction on which the first operand register depends and the load instruction on which the second operand register depends.

10. The method of claim 7, further comprising:
upon receiving a notice of a cache hit associated with the first load instruction, releasing the first load instruction first ID bit position back to the pool of N load instruction IDs; and
upon receiving a notice of a cache hit associated with the second load instruction, releasing the load instruction second ID bit position back to the pool of N load instruction IDs.

11. The method of claim 10, the first dependency vector comprising a first dependency vector first bit and a first dependency vector second bit, the second dependency vector comprising a second dependency vector first bit and a second dependency vector second bit, the first dependency vector first bit being at a position corresponding to the load instruction first ID bit position, and the second dependency vector second bit being at a position corresponding to the load instruction second ID bit position.

12. The method of claim 11, the logical operation on the first dependency vector and the second dependency vector including a logical OR on the first dependency vector first bit and on the second dependency vector first bit, generating a target register dependency vector first bit corresponding to the load instruction first ID bit position, and a logical OR on the first dependency vector second bit and on the second dependency vector second bit, generating a target register dependency vector second bit corresponding to the load instruction second ID bit position.

13. The method of claim 12, an ON state of the target register dependency vector first bit indicating the target register being dependent on the first load instruction, and an ON state of the target register dependency vector second bit indicating the target register being dependent on the second load instruction.

14. The method of claim 13, an OFF state of the first dependency vector second bit indicating the first operand register being independent of the second load instruction, and an OFF state of the second dependency vector first bit indicating the second operand register being independent of the first load instruction.

15. The method of claim 13, further comprising:
upon scheduling the consumer instruction, loading the consumer instruction into a potential replay queue; and
upon receiving a notice of a cache miss associated with the first load instruction, accessing the target register dependency vector and, in response to an ON state of the target register dependency vector first bit, retrieving the consumer instruction from the potential replay queue and replaying the consumer instruction.

16. The method of claim 15, further comprising:
upon receiving a notice of a cache miss associated with the second load instruction, accessing the target register dependency vector and, in response to an ON state of the target register dependency vector first bit, retrieving the consumer instruction from the potential replay queue and replaying the consumer instruction.

17. An apparatus for misspeculation recovery by a processor comprising a plurality of registers, comprising
a scheduler controller, configured to schedule a loading of a register by a load instruction, and to schedule a consumer instruction, the consumer instruction indicating a set of operand registers and a target register; and
a dependency tracking controller, coupled to the scheduler controller, configured to
set in a memory, in association with scheduling the loading of the register by the load instruction, a dependency vector, the dependency vector indicating the register being dependent on the load instruction, and
access the dependency vector, in response to the register being in the set of operand registers, and set in the memory a target register dependency vector, based at least in part on the dependency vector, indicating the target register being dependent on the load instruction.

18. The apparatus of claim 17, the dependency vector for the target register comprising bits, the dependency tracking controller being further configured to:
assign to the load instruction a load instruction ID, from a pool of load instruction IDs; and
set the dependency vector for the target register at a state indicating dependency of the target register on the load instruction, the state indicating dependency of the target register on the load instruction being based, at least in part, on the load instruction ID.

19. The apparatus of claim 18, a program instruction identifier (ID) being appended to the load instruction, the dependency tracking controller being further configured to store an ID assignment record, in association with assigning to the load instruction the load instruction ID, the ID assignment record associating the load instruction ID with the program instruction ID.

20. The apparatus of claim 19, the dependency tracking controller being further configured to release the load instruction ID back to the pool of load instruction IDs in response to receiving a notice of a cache hit associated with the load instruction.

21. The apparatus of claim 20, further comprising a potential replay queue, the potential replay queue being coupled to the scheduler controller, wherein the scheduler controller is further configured to
load the consumer instruction into the potential replay queue upon scheduling the consumer instruction; and
receive a notice of a cache miss associated with the load instruction and, in response,
access the dependency vector for the target register, and
in response to the bits indicating dependency of the target register on the load instruction, to retrieve the consumer instruction from the potential replay queue and replay the consumer instruction.

22. An apparatus for load latency misspeculation recovery, for a process comprising registers, comprising:
means for scheduling a loading of a register by a load instruction;
means for setting a dependency vector for the register, indicating the register having a dependency on the load instruction;
means for scheduling a consumer instruction, the consumer instruction indicating a set of operand registers and a target register; and
means for setting a dependency vector for the target register, in response to the register being in the set of operand registers, the dependency vector for the target register indicating dependency on the load instruction, and the dependency vector for the target register being based at least in part on the dependency vector for the register.

23. The apparatus of claim 22, further comprising
means for retrieving the dependency vector for the target register, from the memory, upon receiving a cache miss notice associated with the load instruction, and
means for scheduling a replay of the consumer instruction, based at least in part on the dependency vector for the target register.

24. The apparatus of claim 23, further comprising:
means for assigning to the load instruction a load instruction identifier (ID),
the means for setting in the memory the dependency vector for the target register being configured to set the dependency vector for the target register at a state indicating dependency of the target register on the load instruction, the state indicating dependency of the target register on the load instruction being based, at least in part, on the load instruction ID.

25. The apparatus of claim 24, a program instruction identifier (ID) being appended to the load instruction, the means for assigning to the load instruction the load instruction ID comprising means for storing an assignment record, the assignment record comprising the load instruction ID and the program instruction ID, and the assignment record being stored according to, and accessible based on the program instruction ID.

26. A method for processor load latency misspeculation recovery:
scheduling a loading of a register by a load instruction;
assigning to the load instruction a load instruction identifier (ID);
setting in a memory a dependency vector, based at least in part on the load instruction ID and indicating the register being dependent on the load instruction;
scheduling a consumer instruction, the consumer instruction indicating a set of instruction operand registers and indicating an instruction target register; and
upon the register being in the set of instruction operand registers, setting in the memory a dependency vector, at a state based at least on the load instruction ID and indicating the instruction target register being dependent at least on the load instruction.

27. The method of claim 26, the register being a first register, the load instruction being a first load instruction, the load instruction ID being a first load instruction ID, and the dependency vector being a first register dependency vector, the method further comprising
scheduling a loading of a second register by a second load instruction;
assigning to the second load instruction a second load instruction ID; and
setting in the memory a second dependency vector, based at least in part on the second load instruction ID and indicating the second register being dependent on the second load instruction.

28. The method of claim 27, the consumer instruction being a first consumer instruction, set of instruction operand registers being a set of first instruction operand registers, and the instruction target register being a first instruction target register, the method further comprising:
scheduling a second consumer instruction, the second consumer instruction indicating a second instruction set of operand registers and indicating a second instruction target register; and
upon the second register being in the second instruction set of operand registers, setting in the memory a dependency vector for the second instruction target register, at a state based at least on the second load instruction ID and indicating the second instruction target register being dependent at least on at least the second load instruction.

29. The method of claim 28, further comprising:
scheduling a third consumer instruction, the third consumer instruction indicating a set of third instruction operand registers and a third instruction target register; and
upon the first instruction target register being in the third instruction set of operand registers, setting in the memory a dependency vector for the third instruction target register, the dependency vector for the third instruction target register based at least on the dependency vector for the first instruction target register, and indicating the third instruction target register being dependent at least on the first load instruction.

30. The method of claim 29, further comprising:
upon the first instruction target register and the second instruction target register being in the third instruction set of operand registers, setting the dependency vector for the third instruction target register based at least on the dependency vector for the first instruction target register and the dependency vector for the second instruction target register, and indicating the third instruction target register being dependent at least on the first load instruction and on the second load instruction.
